(19) United States
(12) Patent Application Publication
(10) Pub. No.: US 2004/0241280 A1
(43) Pub. Date: Dec. 2, 2004

(54) Method and composition of an alcoholic substance with a dessert food flavoring and reduced after-imbibing effect

(76) Inventor: Susan T. Saladino, Mt. Morris, IL (US)

Correspondence Address: LEYDIG VOIT & MAYER, LTD, 6815 WEAVER ROAD, ROCKFORD, IL, 61114-8018, US

(21) Appl. No.: 10/706,131

(22) Filed: Nov. 12, 2003

Related U.S. Application Data
(60) Provisional application No. 60/425,520, filed on Nov. 12, 2002.

(51) Int. Cl. C12C 11/00

(52) U.S. Cl. 426/11

(57) ABSTRACT

An alcoholic beverage with dessert food flavoring and method for producing is disclosed that is independent of a vodka component. The method includes combining approximately one part apple cider with two parts apple juice, adding approximately one third part sugar, adding a predetermined amount of cinnamon, simmering the combined apple cider, apple juice, sugar and cinnamon for up to three hours, and after cooling, adding up to one-half part grain alcohol. One embodiment is directed to, after adding the grain alcohol, bottling the alcoholic beverage with a predetermined amount of cinnamon sticks. A further embodiment is directed to simmering the combined apple cider and apple juice with a single cinnamon stick if a wet part is approximately one-half gallon.

### CROSS-REFERENCE TO RELATED PATENT APPLICATIONS

This patent application claims the benefit of U.S. Provisional Patent Application No. 60/425,520, filed Nov. 12, 2002.

### FIELD OF THE INVENTION

This invention pertains to a process for making an alcoholic beverage with a flavor of apple pie and reduced risk of hangover.

### BACKGROUND OF THE INVENTION

As is known, there are a plethora of methods available online and else where for making alcoholic beverages. Beverages that have a flavor commonly associated with dessert foods have been attempted, however few have been successful in both providing an enjoyable alcoholic beverage while masking any alcohol flavor by overwhelming the palate with a dessert food flavor. Likewise, it is known that alcoholic beverages often produce unwanted side effects such as hangovers, headaches and the like. What is needed is an enjoyable alcoholic beverage with masking abilities independent of after-imbibing effect. In particular, many alcoholic beverages with attempted dessert food flavoring use some form of vodka as the alcohol component. Unfortunately, alcoholic beverages with vodka as a component produce after-imbibing effects for susceptible individuals. An alcoholic beverage with dessert-food type flavoring without such a vodka component is needed. The invention provides such an alcoholic beverage. These and other advantages of the invention, as well as additional inventive features, will be apparent from the description of the invention provided herein.

### BRIEF SUMMARY OF THE INVENTION

The invention provides a composition of matter that is an alcoholic beverage with dessert food flavoring that is independent of a vodka component and method for producing the composition of matter. The method includes several elements. The primary elements of the method include combining approximately one part apple cider with two parts apple juice, adding approximately one third part sugar, adding a predetermined amount of cinnamon, simmering the combined apple cider, apple juice, sugar and cinnamon for up to three hours, and after cooling, adding up to one-half part grain alcohol.

Different embodiments of the invention are within the scope of the disclosure. One embodiment is directed to, after adding the grain alcohol, bottling the alcoholic beverage with a predetermined amount of cinnamon sticks. Also, regarding the parts, if dry sugar cane-type sugar is used, one-third part can be three cups, and each wet part can be one-half gallon. Further, an embodiment is directed to simmering the combined apple cider and apple juice with a single cinnamon stick if a wet part is approximately one-half gallon.

Another embodiment of the present invention is directed to a composition of matter that has a dessert food flavor independent of an alcohol flavor. More particularly, a manufactured alcoholic substance with dessert food flavoring, the alcoholic substance includes a sweetened apple cider and juice combination component, a cinnamon component and a grain alcohol component. The sweetened apple cider and juice combination component, the cinnamon component and the grain alcohol component are combined after the cinnamon component is processed to add flavor to the sweetened apple cider and juice component. The grain alcohol component is preferably no more than one sixth of the total liquids in the combination. Advantageously, the combination is independent of vodka to provide a reduced after-imbibing effect, especially for susceptible individuals. The sweetened apple cider and juice combination can be approximately one part apple cider with two parts apple juice and the grain alcohol component is up to one-half part grain alcohol. In one embodiment, the alcoholic substance combination further includes a gum-based thickening agent enabling the alcoholic substance to be used as a confection topping.

### BRIEF DESCRIPTION OF THE DRAWINGS

FIG. 1 is a flow diagram illustrating a method according to an embodiment of the present invention.

FIG. 2 is a diagram of an alcoholic substance showing components used in a manufacturing process according to an embodiment of the present invention.

### DETAILED DESCRIPTION OF THE INVENTION

The following examples further illustrate the invention but, of course, should not be construed as in any way limiting its scope.

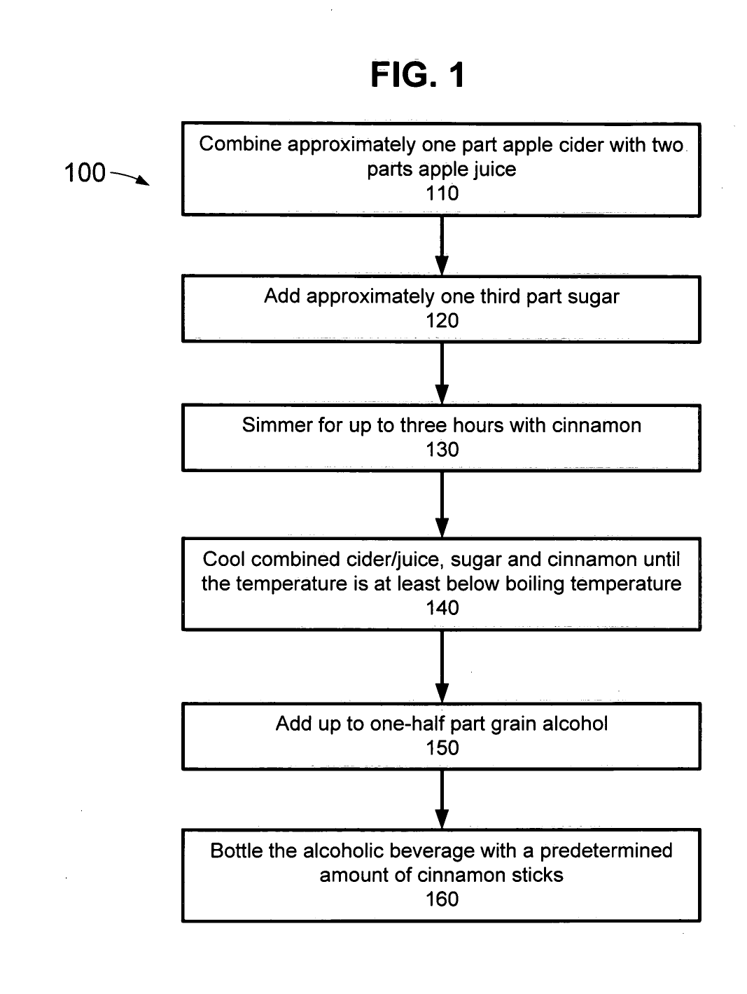

Referring to FIG. 1, a flow diagram is shown illustrating an embodiment according to the present invention. More particularly, a method for preparing an alcoholic beverage is described in flow diagram 100. Block 110 provides for combining approximately one part apple cider with two parts apple juice. The apple cider is preferably a clarified apple cider. Block 120 provides for adding approximately one third part sugar or other appropriate dry sweetener of a similar chemical makeup to white cane sugar. Block 130 provides for simmering the combined apple cider, apple juice and sugar for up to three hours with the equivalent of a cinnamon stick or two. Block 140 provides for cooling the combined apple cider/juice, sugar and cinnamon until the temperature is at least below boiling temperature. After cooling, block 150 provides for adding up to one-half part grain alcohol. One embodiment is directed to, as shown in block 160, after adding the grain alcohol, bottling the alcoholic beverage with a predetermined amount of cinnamon sticks.

Regarding the parts, if dry sugar cane-type sugar is used, one-third part can be approximately three cups, and each wet part can be approximately one-half gallon. Further, an embodiment is directed to simmering the combined apple cider and apple juice with a single cinnamon stick if a wet part is approximately one-half gallon.

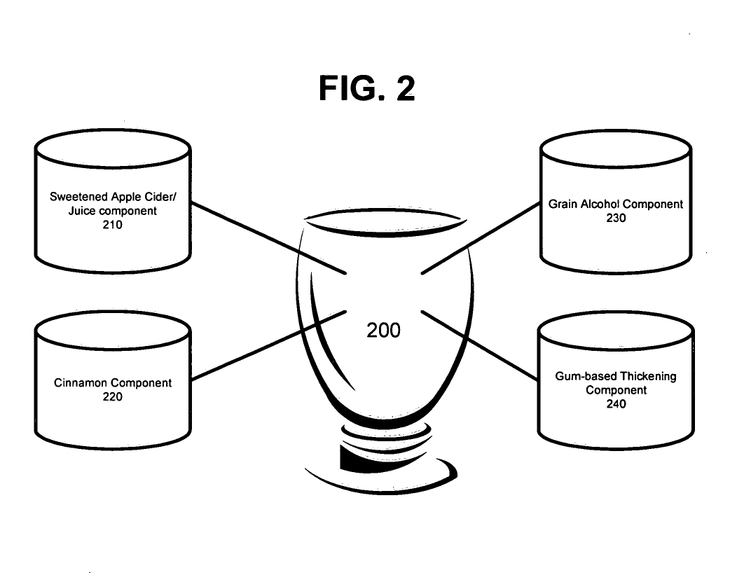

Another embodiment of the present invention is directed to a composition of matter that has a dessert food flavor independent of an alcohol flavor. More particularly, referring to FIG. 2, a manufactured alcoholic substance with dessert food flavoring, is shown. The alcoholic substance 200 includes a sweetened apple cider and juice combination component 210, a cinnamon component 220 and a grain alcohol component 230. The sweetened apple cider and juice combination component, the cinnamon component and the grain alcohol component are combined after the cinnamon component is processed to add flavor to the sweetened apple cider and juice component. The grain alcohol component is preferably no more than one sixth of the total liquids in the combination. Advantageously, the combination is independent of vodka to provide a reduced after-imbibing effect, especially for susceptible individuals. The sweetened apple cider and juice combination can be approximately one part apple cider with two parts apple juice and the grain alcohol component is up to one-half part grain alcohol. In one embodiment, the alcoholic substance combination further includes a gum-based thickening agent 240 enabling the alcoholic substance to be used as a confection topping. For example, a thickened version of the alcoholic substance is appropriate as an ice cream topping.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for producing an alcoholic beverage with dessert food flavoring, the method comprising:
combining approximately one part apple cider with two parts apple juice;
adding approximately one third part sugar;
adding a predetermined amount of cinnamon;
simmering the combined apple cider, apple juice, sugar and cinnamon for up to three hours;
cooling the combined apple cider, apple juice, sugar and cinnamon until a temperature of under boiling temperature is reached; and
after cooling, adding up to one-half part grain alcohol.

2. The method of claim 1 further comprising:
after adding the grain alcohol, bottling the alcoholic beverage with a predetermined amount of cinnamon sticks.

3. The method of claim 1 further comprising:
pouring the alcoholic beverage over ice cream.

4. The method of claim 1 wherein:
if the sugar is dry sugar cane-type sugar, the one third part is approximately three cups; and
each part of the apple cider, apple juice and grain alcohol is approximately one-half gallon.

5. The method of claim 1 wherein the apple cider is a clarified-type apple cider.

6. An alcoholic beverage with dessert food flavoring, the alcoholic beverage comprising a composition of matter formed by performing the steps of:
combining approximately one part apple cider with two parts apple juice;
adding approximately one third part sugar;
adding a predetermined amount of cinnamon;
simmering the combined apple cider, apple juice, sugar and cinnamon for up to three hours;
cooling the combined apple cider, apple juice, sugar and cinnamon until a temperature of under approximately a boiling temperature is reached; and
after cooling, adding up to one-half part grain alcohol.

7. The alcoholic beverage of claim 6 wherein the composition of matter is produced by performing the further step of, after adding the grain alcohol, bottling the alcoholic beverage with a predetermined amount of cinnamon sticks.

8. The alcoholic beverage of claim 6 wherein the composition of matter is produced by performing the further step of pouring the alcoholic beverage over ice cream.

9. The alcoholic beverage of claim 6 wherein:
if the sugar is dry sugar cane-type sugar, the one third part is approximately three cups; and
each part of the apple cider, apple juice and grain alcohol is approximately one-half gallon.

10. The alcoholic beverage of claim 6 wherein the apple cider is a clarified-type apple cider.

11. A manufactured alcoholic substance with dessert food flavoring, the alcoholic substance comprising:
a sweetened apple cider and juice combination component;
a cinnamon component; and
a grain alcohol component, wherein the sweetened apple cider and juice combination component, the cinnamon component and the grain alcohol component are combined after the cinnamon component is processed to add flavor to the sweetened apple cider and juice component, the grain alcohol component being no more than one sixth of the total liquids in the combination, the combination independent of vodka to provide a reduced after-imbibing effect.

12. The alcoholic substance of claim 11 wherein the sweetened apple cider and juice combination is approximately one part apple cider with two parts apple juice and the grain alcohol component is up to one-half part grain alcohol.

13. The alcoholic substance of claim 11 wherein the combination further includes a gum-based thickening agent enabling the alcoholic substance to be used as a confection topping.
